(19) United States
(12) Patent Application Publication
(10) Pub. No.: US 2025/0071596 A1
(43) Pub. Date: Feb. 27, 2025

(54) PROVIDING DYNAMIC QUALITY OF SERVICE FOR DEVICES CONNECTED TO A WIRELESS NETWORK

(71) Applicant: Verizon Patent and Licensing Inc., Basking Ridge, NJ (US)

(72) Inventors: Deepak Majjiga, Irving, TX (US); Raghuram Parvataneni, Irving, TX (US)

(21) Appl. No.: 18/237,532

(22) Filed: Aug. 24, 2023

(51) Int. Cl. H04W 28/02

(52) U.S. Cl. CPC H04W 28/0215; H04W 28/0236; H04W 28/0268

(57) ABSTRACT

One or more computing devices, systems, and/or methods for implementing dynamic quality of service for devices are provided. Generating a classification associated with a device, connected to the wireless network through a router. Service details for the device are stored, and correspond to expected wireless network quality of service that is to be provided by the wireless network to the device and corresponds to the classification (e.g., device classification, application classification, and experience mode classification), and/or other factors such as time and location. A current wireless network quality of service obtained from the device is compared with the service details to identify a delta. Wireless network quality of service for the device is modified based upon the delta. In this way, network side modifications and/or WiFi router side modifications may be performed.

### BACKGROUND

Many types of devices are capable of connecting to and communicating over a wireless network such as a WiFi network. The wireless network may include a router that implements communication routing functionality. Laptops, smartphones, thermostats, smart speakers, and a wide variety of other devices can connect to the router in order to communicate over the wireless network. The devices may be capable of communicating with one another over the wireless network through the router. The router may be connected to a modem that provides connectivity over a different network such as access to the Internet. In this way, the devices connected to the router can access various services, websites, and/or content providers over the Internet.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 is a diagram illustrating an example of a system for providing dynamic quality of service for devices connected to a wireless network, in accordance with an embodiment of the present technology;

FIG. 2 is a flow chart illustrating an example method for providing dynamic quality of service for devices connected to a wireless network, in accordance with an embodiment of the present technology;

FIG. 3 is a diagram illustrating an example of a system for providing dynamic quality of service for devices connected to a wireless network such as a multipurpose device, in accordance with an embodiment of the present technology;

FIG. 4 is an illustration of a device registry, in accordance with an embodiment of the present technology;

FIG. 5 is an illustration of a domain name service mapper, in accordance with an embodiment of the present technology;

FIG. 6 is an illustration of example networks that may utilize and/or implement at least a portion of the techniques presented herein;

FIG. 7 is an illustration of a scenario involving an example configuration of a computer that may utilize and/or implement at least a portion of the techniques presented herein;

FIG. 8 is an illustration of a scenario involving an example configuration of a client that may utilize and/or implement at least a portion of the techniques presented herein;

FIG. 9 is an illustration of a scenario featuring an example non-transitory machine readable medium in accordance with one or more of the provisions set forth herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof. The following provides a discussion of some types of computing scenarios in which the disclosed subject matter may be utilized and/or implemented.

End devices such as cell phones, smart televisions, videogame consoles, virtual reality headsets, home smart devices, and/or a variety of other devices may connect to a wireless network such as a WiFi network through a router. These devices may be able to communicate over a local area network provided by the router and/or are provided with Internet access such as through a modem connected to the router. When the devices connect to the wireless network, all of the devices and applications hosted on the devices will experience the same quality of service. In particular, the router will treat all connected devices in the same manner and with the same quality of service. Unfortunately, different devices and different applications may have different performance requirements at different venues and times (e.g., at home, at a videogame shop, at a virtual reality experience center, etc.) in order to correctly operate and provide desired experiences for users (e.g., playing a videogame without network lag and/or with at least 30 frames per second). For example, a messenger application may consume a small amount of compute, memory, network bandwidth, and/or other resources in order to operate as designed. In contrast, an online videogame may consume a much larger amount of compute, memory, network bandwidth, and/or other resources in order to operate as designed compared to the messenger application.

A network operator is unaware of how certain end devices and applications are performing, and cannot control quality of service for individual devices that are connected to the wireless network through fixed wireless access (WiFi Modem or router). In order to control quality of service for a particular device, the device must be uniquely identified. However, media access control addresses of devices can be spoofed or changed, thus cannot be considered unique. Therefore, media access control addresses of devices cannot be relied upon for device identification. Furthermore, it is not possible to differentiate between applications hosted by the same device, and thus different quality of service cannot be offered for the different applications. For example, a mobile phone may host a computationally intensive photo editing application and a simple banking application, which will both receive the same quality of service. Even if WiFi quality of service could be adjusted by the router for certain devices or applications, bottlenecks could still occur. The bottlenecks can occur where congestion is experienced in the backhaul because slice quality of service is not additionally adjusted or can occur where WiFi quality of service is not adjusted in coordination of slice quality of service. That is, a bottleneck can occur within the backhaul when only the WiFi quality of service is adjusted. Also, a bottleneck can occur in the wireless network when the WiFi quality of service is not adjusted in coordination with the backhaul/slice quality of service.

The techniques provided herein solve these technical problems and improve the operation of devices connected to a wireless network (e.g., indirectly connected to the wireless network through a WiFi router) and applications executing on the devices by dynamically implementing quality of service for the devices and applications. Implementing dynamic quality of service includes functionality hosted within a router of the wireless network, functionality to identify end devices connected to the wireless network, functionality within a network operator to dynamically control quality of service on a per application basis, a quality of service controller that changes quality of service for a particular application based upon an application call from the application, and functionality to retrieve what quality of service to apply for an application. Dynamic quality of service provides customized and differentiable device and application operation that improves the operation of devices, the execution of applications, and user experience by controlling quality of services for various devices and applications connected to a same wireless network. Wireless network quality of service (WiFi quality of service) and slice key performance indicators can be dynamically adjusted so that devices and applications receive the compute, memory, and network resources that will provide for improved performance without the creation of bottlenecks.

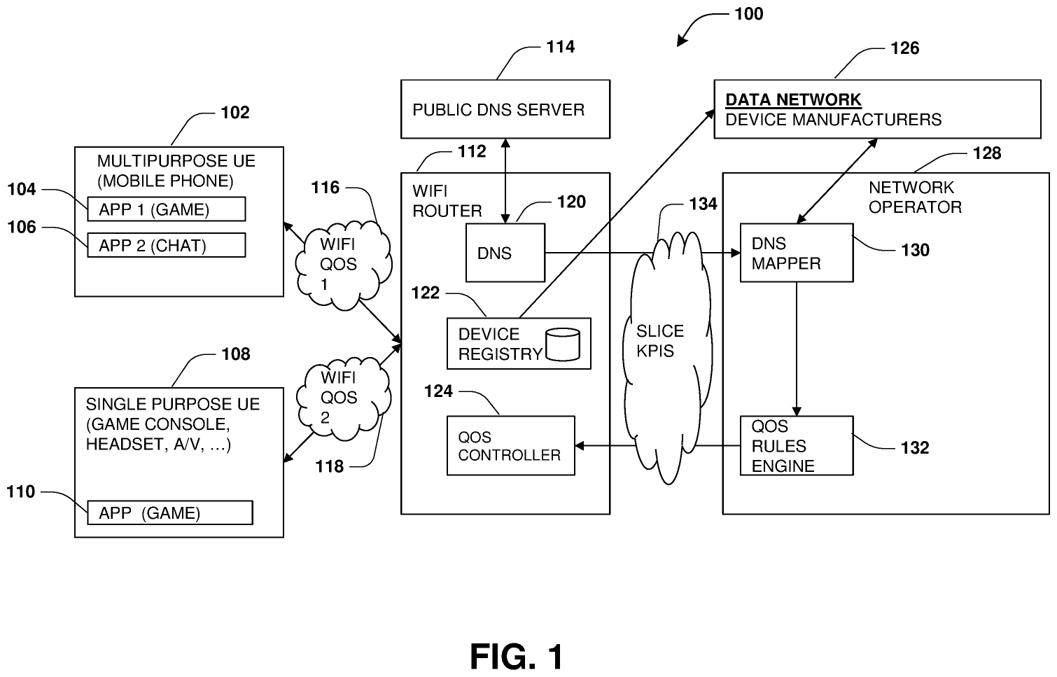

FIG. 1 is a diagram illustrating an example of a system 100 for providing dynamic quality of service for devices connected to a wireless network such as a WiFi network. The wireless network includes a router 112. The router 112 is communicatively coupled to a network operator 128. The router 112 implements a domain name service 120 that connects to a public domain name server 114 in order to provide domain name service functionality for devices connected to the wireless network. A multipurpose device 102 (e.g., a mobile phone) and a single purpose device 108 (e.g., a video game console, a headset, audio/visual equipment, etc.), and/or other devices are connected to the wireless network through the router 112. The multipurpose device 102 may host a first application 104 (e.g., a computationally and graphically intensive game) and a second application 106 (e.g., a simple chat application). The single purpose device 108 may host an application 110 (e.g., non-graphically intensive, but computationally intensive game).

Dynamic quality of service can be implemented for the multipurpose device 102, the first application 104 hosted by the multipurpose device 102, the second application 106 hosted by the multipurpose device 102, the single purpose device 108, the application 110 hosted by the single purpose device 108, and/or other devices and applications. In order to implement the dynamic quality of service, a quality of service controller 124 and a device registry 122 are hosted within the router 112, and a domain name service mapper 130 and a quality of service rules engine 132 are hosted within the network operator 128. Dynamic quality of service may include dynamically modifying WiFi quality of service 116 provided to the multipurpose device 102 (or at a per application granularity), WiFi quality of service 118 provided to the single purpose device 108, and/or slice key performance indicators 134.

The device registry 122 is used to track and identify each device that is connected to the wireless network so that quality of service can be dynamically implemented on a device by device basis as opposed to all devices receiving the same quality of service. The device registry 122 connects to a data network 126 so that the device registry 122 can utilize device information provided by device manufacturer services within the data network 126 for identifying and classifying devices tracked by the device registry 122. In some embodiments when a device attempts to reconnect to the router 112, the device registry 122 is queried to identify the device classification of the device.

The domain name service mapper 130 connects to the data network 126 in order to retrieve service details for a device from a device manufacturer service associated with the device. The service details may include expected wireless network quality of service (e.g., expected WiFi quality of service) for the device. The expected wireless network quality of service may include expected uplink, downlink, bandwidth, throughput, latency, and/or a variety of other quality of service metrics. The domain name service mapper 130 provides the service details to the quality of service rules engine 132.

The quality of service rules engine 132 utilizes the service details and current quality of service experienced by applications and devices in order to adjust the slice key performance indicators 134 and/or instruct the quality of service controller 124 to adjust the wireless network quality of service such as WiFi quality of service 116 and WiFi quality of service 118. The wireless network and slice key performance indicators 134 may be dynamically modified as a device switches between different applications so that dynamic quality of service is provided at an application level granularity in real-time as different applications as executed by a device.

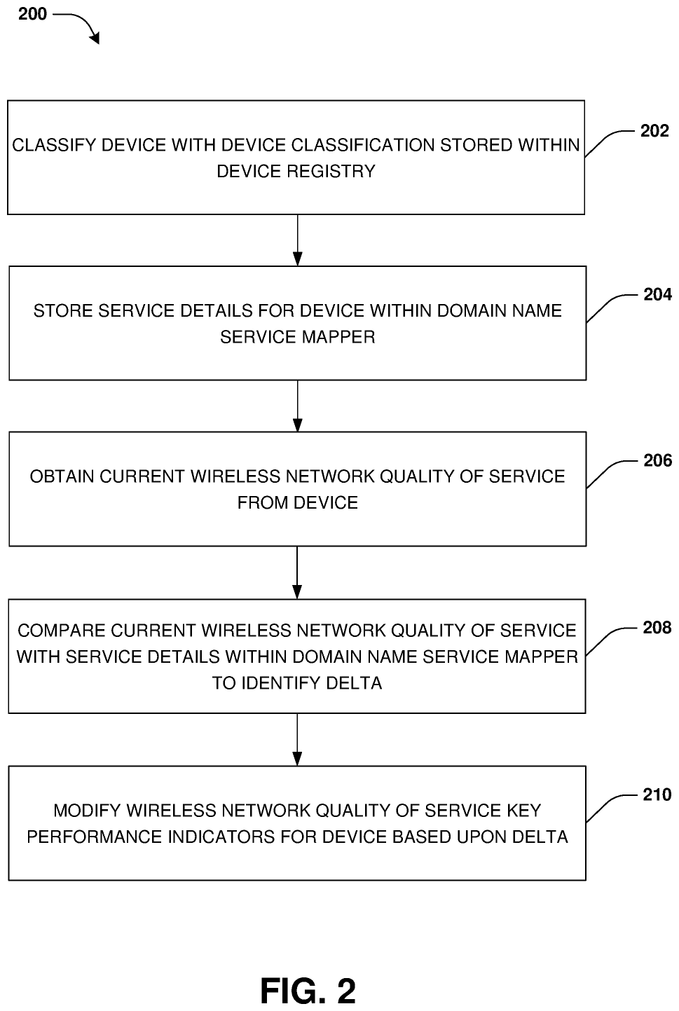

FIG. 2 is a flow chart illustrating an example method 200 for providing dynamic quality of service for devices connected to a wireless network. As part of providing dynamic quality of service for devices and applications, the devices are classified with device classifications, which helps track devices so that different quality of service can be provided to each of the devices and/or each of the applications hosted on the devices. During operation 202 of method 200, a device connected to the wireless network (e.g., connected to a router of a WiFi network) is classified with a device classification that is stored within a device registry. In some embodiments of classifying the device, a media access control address of the device is obtained by the router. The media access control address is evaluated to identify a manufacturer of the device (e.g., a manufacturer of a particular smart phone, a manufacturer of a particular videogame console, etc.). The media access control address is used to perform an application programming interface call to a service (e.g., a manufacturer service within a data network) to obtain device details of the device. The device details may specify the type of device (e.g., a multipurpose smart phone, a single purpose videogame system, a single purpose smart thermostat, a single purpose smart speaker, etc.). In this way, the device details are used to classify the device with the device classification, such as a multipurpose device or a single purpose device.

In some embodiments of classifying the device, a user may assign a name to the device (e.g., “downstairs thermostat”) as a device name. The router may obtain the device name from the device, and evaluate the device name to identify the device classification to assign to the device. The router may utilize functionality (e.g., text parsing functionality, keyword extraction functionality, a mapping between keywords and device types, etc.) to extract keywords from the device name that are indicative of types of devices such as “thermostat,” “speaker,” “phone,” etc. The keywords may be mapped to device classifications (e.g., “thermostat” being mapped to single purpose device). In this way, the device classification is assigned based upon the device name.

In some embodiments of classifying the device, a manufacturer of the device may preconfigure the device with preconfigured device details and/or preconfigured quality of service information. The router may access the preconfigured device details and/or the preconfigured quality of service information from the device. The device may be classified with the device classification based upon the preconfigured device details. The preconfigured quality of service information may be used to derive expected wireless network quality of service (e.g., expected WiFi quality of service) that is to be provided to the device.

During operation 204 of method 200, services details for the device are obtained and stored within a domain name service mapper. The service details correspond to an expected wireless network quality of service to be provided by the wireless network to the device and corresponds to the device classification. In some embodiments, the domain name service mapper is populated with an entry for the device based upon the service details. The entry is populated with a destination IP address, an application identifier of an application hosted within the device, an application type (e.g. a gaming app with high computational and graphical requirements, a text messaging app with low computational and graphical requirements, etc.), and the expected wireless network quality of service. The service details may include expected slice quality of services for different applications hosted on the device such as a first expected slice quality of service for a first application and a second expected slice quality of service for a second application, which may be stored within the entry in the domain name service mapper.

During operation 206 of method 200, a current wireless network quality of service is obtained for the device. The current wireless network quality of service may relate to latency, bandwidth, compute, resource utilization, packet loss information, and/or variety of other metrics (e.g., performance metrics for key performance indicators) indicative of performance of the device and/or applications executed by the device. During operation 208 of method 200, the current wireless network quality of service is compared with the service details within the entry in the domain name service mapper for the device to identify a delta (e.g., a difference between expected and actual/current latency, bandwidth, uplink, downlink, throughput, etc.). In this way, the delta represents what performance the device is to receive and is not receiving.

During operation 210 of method 200, the wireless network quality of service is modified based upon the delta. In some embodiments, a quality of service rules engine within a network operator determines the delta, which is pushed to a quality of service rules engine within the network operator. The quality of service rules engine instructs a quality of service controller within the router to modify wireless network quality of service for the device based upon the delta (e.g., increase resources, network bandwidth, network traffic priority, throughput, etc.). In particular, there is a slice quality of service and a wireless network quality of service (e.g., a WiFi quality of service such as a WiFi router quality of service). The quality of service rules engine performs a check to determine if a slice is to be changed completely, the slice quality of service of the slice is to be adjusted, or there is no change to the slice but a change in the WiFi quality of service is to be made. If merely the WiFi quality of service is to be changed, then the quality of service rules engine sends instructions of a delta to the quality of service controller in the router for performing the change to the WiFi quality of service.

In some embodiments, the quality of service rules engine pushes quality of service values to the quality of service controller based upon a predefined configuration provided by a device service/provider of the device (a device manufacturer service within the data network). The quality of service controller utilizes the quality of service values to modify wireless network quality of service, such as latency, bandwidth, throughput, etc.

In some embodiments where the device is classified as a multipurpose device capable of serving multiple applications or types (e.g., applications may be hosted in web servers and are served by end user devices), end to end quality of service management is performed for the device. As part of performing end to end quality of service management for the device, the wireless network quality of service and slice key performance indicators are modified for the device (network slice metrics such as downlink throughput of a network slice, packet loss of a network slice, latency of a network slice, etc.). In some embodiments, a determination is made that slice key performance indicators are to be modified for the device or entire slice (S-NSSAI can be changed (added/removed) within allowed S-NSSAIs). Accordingly, a determination is made as to whether a user of the device is subscribed for a slice (a particular network slice) through a unified data manager. In response to the user being subscribed to the slice, network slice selection functionality may be updated based upon a proposal provided by an application provider of an application of the device. If the slice key performance indicators can be modified without changing network slice selection functionality, then a configuration change may be pushed to a policy control function, a session management function, user plane function or an access and mobility management function. Additionally, a transport configuration may be updated for modification of the slice key performance indicators. In this way, slice key performance indicators may be modified as part of providing dynamic quality of service for devices.

In some embodiments, dynamic quality of service is provided at an application level granularity where different applications are provided with different quality of service based upon application needs. An application executing on the device may perform an application programming interface (API) call to an application provider for a quality of service set for the application (e.g., expected resources, expected network bandwidth, expected latency, expected throughput, etc.). An application provider response may be received from the application provider. The application provider response defines the quality of service set to apply for the application. In response to determining that the device is executing the application, the quality of service set is applied by the router for the application. In some embodiments, a first quality of service set is applied by the router based upon the router determining that the device is executing a first application. The router applies a second quality of service set based upon the router determining that the device switched to executing a second application.

In some embodiments, quality of service provided to the device is dynamically changed based upon application calls received from applications executing on the device. A particular quality of service is provided to the device based upon an application call received from a particular application currently executing on the device. In some embodiments, quality of service may vary for the same application based upon different modes of operation (experience modes) of the application. For example, a video streaming application has different quality of service requirements based upon whether the video streaming application is operating at 120 pixels, 240 pixels, 480 pixels, 1040 pixels, 4 k, 8 k, etc. In another example, if the format of the same video changes from virtual reality to augmented reality, then the quality of service may completely change, and thus the experience mode is a factor. In some embodiments, the quality of service requirements for the same application can change based upon time such as where more users may be utilizing the same application (e.g., a game such as a multi-user free world game) during peak hours or holidays. In some embodiments, quality of service requirements change based upon location such as during a drone competition where a drone may hop from one WiFi network to another WiFi network due to moving long distances. In this way, quality of service can take into account any number and combination of factors such as different device types, application types, experience modes, time, location, and/or other factors.

In some embodiments, the domain name service mapper may receive a request for the expected wireless network quality of service for the device. The domain name service mapper may provide the expected wireless network quality of service to an application served by the device. The device can provide the expected wireless network quality of service to the router so that the router can apply the expected wireless network quality of service for the application.

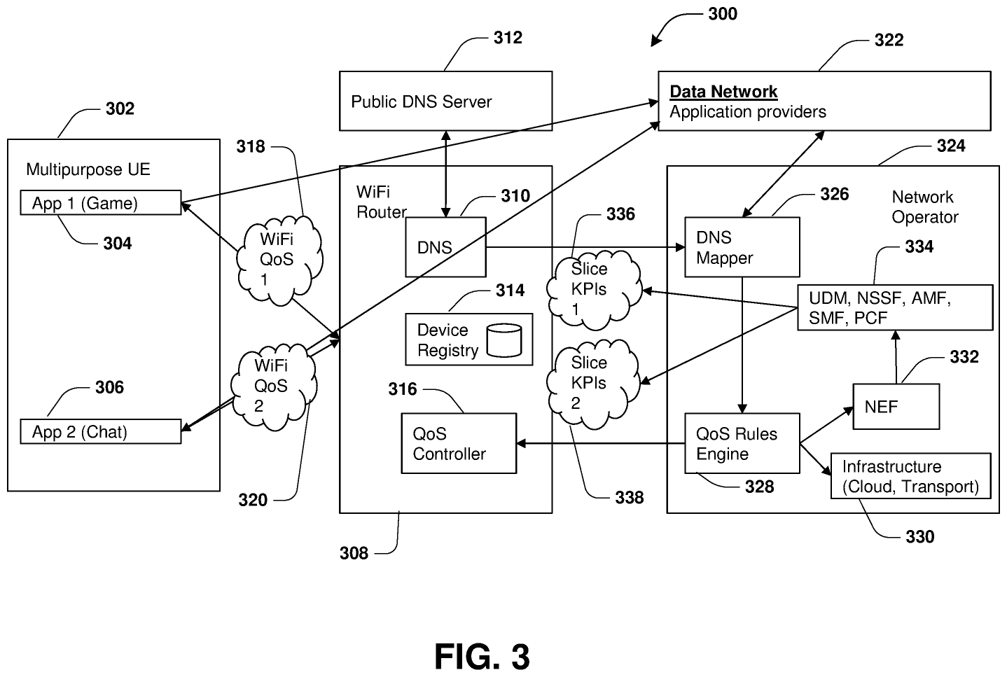

FIG. 3 is a diagram illustrating an example of a system 300 for providing dynamic quality of service for a multipurpose device 302 connected to a wireless network such as a WiFi network. The multipurpose device 302 may serve a first application 304 such as a game that requires a first amount of compute and network resources for desired operation (e.g., enough network bandwidth so that the game does not lag, enough compute and graphic resources to achieve a certain frames per second, etc.). The multipurpose device 302 may serve a second application 306 such as a chat app that requires a second amount of compute and network resources for desired operation (e.g., a relatively small amount of compute and network resources compared to the game).

The wireless network includes a router 308 connected to a network operator 324. The router 308 implements a domain name service 310 that connects to a public domain name server 312 in order to provide domain name service functionality for the multipurpose device 302. In order to implement dynamic quality of service for the multipurpose device 302, the first application 304, and the second application 306, a quality of service controller 316 and a device registry 314 are hosted within the router 308, and a domain name service mapper 326 and a quality of service rules engine 328 are hosted within the network operator 324. Dynamic quality of service may include dynamically modifying first WiFi quality of service 318 (wireless network quality of service) for the first application 304, second WiFi quality of service 320 (wireless network quality of service) for the second application 306, first slice key performance indicators 336 for the first application 304, second slice key performance indicators 338 for the second application 306, and/or by changing (add or removing) a slice (S-NSSAI) within allowed S-NSSAIs).

The device registry 314 is used to track and identify each device that is connected to the wireless network such as the multipurpose device 302 so that quality of service can be dynamically implemented on a device by device basis as opposed to all devices receiving the same quality of service. The device registry 314 connects to a data network 322 so that the device registry 314 can utilize device information provided by device manufacturer services within the data network 322 for identifying and classifying devices tracked by the device registry 314.

The domain name service mapper 326 connects to the data network 322 in order to retrieve service details for a device from a device manufacturer service associated with the device. The service details may include expected wireless network quality of service (e.g., expected WiFi quality of service) and/or expected slice quality of service for the device. In some embodiments, device manufacturers provide breakdowns of expectations on slice and WiFi quality of service, and in other embodiments, device manufactures or application provides merely provide expected overall quality of service. An operator rule engine may categorize, split, or break such information into slice key performance indicators and WiFi quality of service The expected wireless network quality of service may include expected upload packet loss, download packet loss, bandwidth, throughput, latency, and/or a variety of other quality of service metrics. The domain name service mapper 326 provides the service details to the quality of service rules engine 328.

In response to determining that a particular application is currently being executed by the multipurpose device 302, the quality of service rules engine 328 utilizes the service details and current quality of service experienced by the multipurpose device 302 in order to instruct the quality of service controller 316 to adjust the wireless network quality of service such as to provide the first application with the first WiFi quality of service 318 or the second application with the second WiFi quality of service 320. The wireless network quality of service may be dynamically modified as the multipurpose device 302 switches between different applications so that dynamic quality of service is provided at an application level granularity.

In response to determining that slice key performance indicators are to be modified (e.g., the first slice key performance indicators 336 for the first application 304, the second slice key performance indicators 338 for the second application 306, etc.), the quality of service rules engine 328 facilitates the modification of such slice key performance indicators. If the slice key performance indicators are to be modified, then a network slice selection function is updated with proposed single network slice selection assistance information provided by an application provider of the application. In some embodiments, if the slice key performance indicators can be altered without changing the single network slice selection assistance information, then the quality of service rules engine pushes configuration changes to network functions 334 (e.g., a policy control function, a session management function, an access and mobility management function, a unified data manager, network slice selection function, a user plane function, etc.) via a network exposure function 332 for implementation. The quality of service rules engine 328 also pushes configurations to infrastructure 330 such as Cloud or transport.

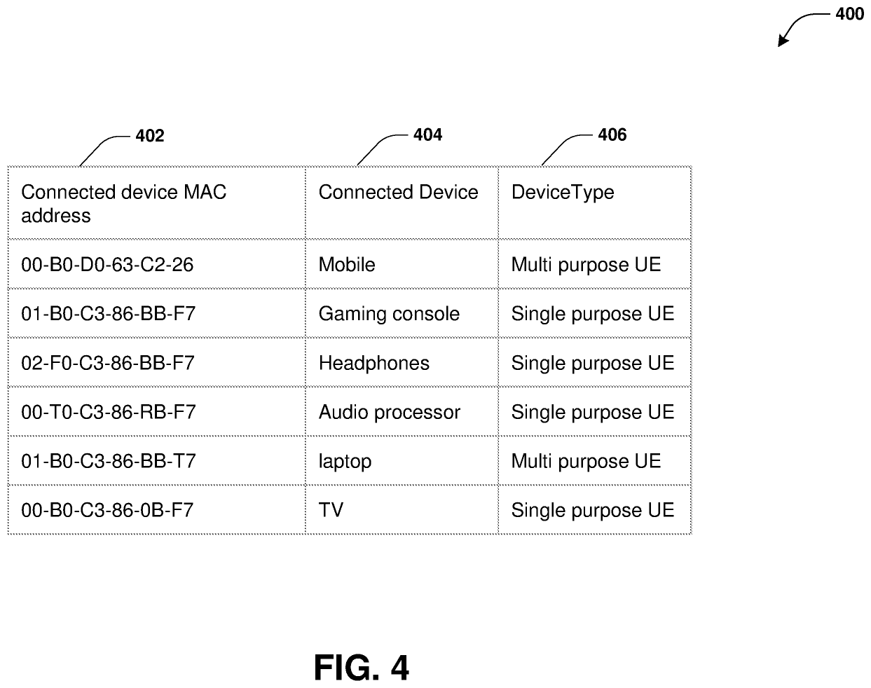

FIG. 4 is an illustration of a device registry 400. The device registry 400 is populated with entries for devices that are identified as being connected to a wireless network. The device registry 400 may be hosted within a router of the wireless network. Each entry may include a media access control address 402, a connected device 404 (e.g., a name or generic device category), and a device type 406 (e.g., a multipurpose device capable of executing different types of applications or a single purpose device that executes a single type of application).

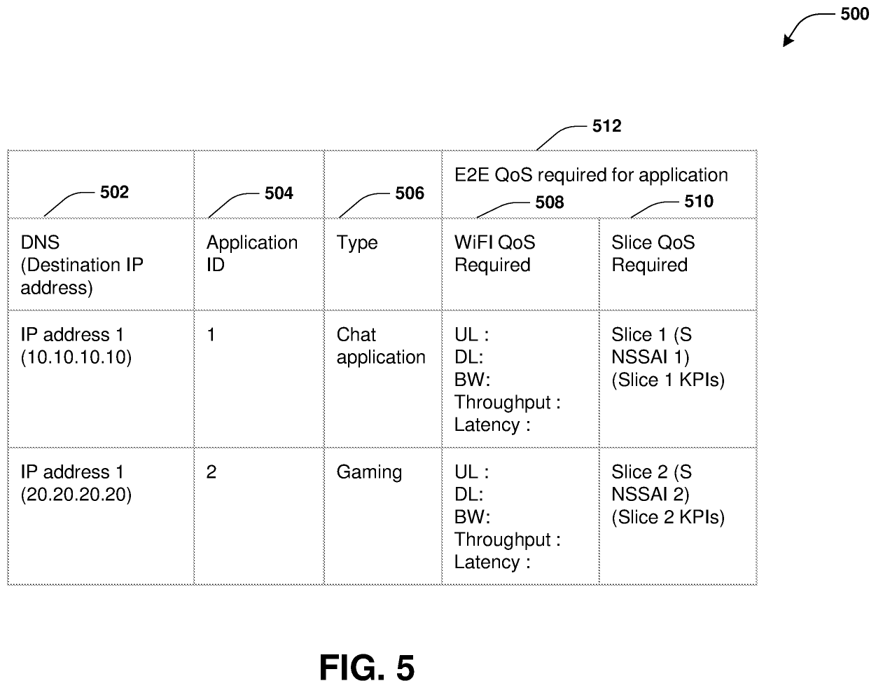

FIG. 5 is an illustration of a domain name service mapper 500. The domain name service mapper 500 may be hosted within a network operator of a wireless network. The domain name service mapper 500 is populated with entries that include a destination IP address 502, an application identifier 504 of a particular application served by a device connected to the wireless network, an application type 506 of the application, an expected wireless network quality of service 508 (WiFi quality of service required), and an expected slice quality of service 510 (slice quality of service required). The expected wireless network quality of service 508 and the expected slice quality of service 510 are part of end to end quality of service 512 expected for an application.

According to some embodiments, a method is provided. The method includes generating a classification associated with a device connected to a wireless network through a router; storing service details for the device, wherein the service details correspond to expected wireless network quality of service to be provided by the wireless network to the device and corresponds to the classification; obtaining a current wireless network quality of service from the device; comparing the current wireless network quality of service with the service details for the device to identify a delta; and modifying wireless network quality of service for the device based upon the delta.

According to some embodiments, the method includes evaluating a media access control address of the device to identify a manufacturer of the device; utilizing the media access control address to perform an application programming interface call to a service to obtain device details of the device; and classifying the device as a single purpose device or a multipurpose device based upon the device details.

According to some embodiments, the method includes identifying a device name of the device; and classifying the device as a single purpose device or a multipurpose device based upon the device name.

According to some embodiments, the method includes accessing preconfigured device details and preconfigured quality of service information from the device; classifying the device as a single purpose device or a multipurpose device based upon the preconfigured device details; and utilizing the preconfigured quality of service information to derive the expected wireless network quality of service.

According to some embodiments, the method includes in response to detecting a reconnection of the device, querying the device registry to identify the classification of the device.

According to some embodiments, the method includes populating a domain name service mapper with an entry for the device, within the entry is populated with a destination IP address, an application identifier, an application type, and the expected wireless network quality of service.

According to some embodiments, the method includes pushing, by a quality of service rule engine, quality of service values to a quality of service controller based upon a predefined configuration from a device provider of the device, wherein the quality of service controller utilizes the quality of service values to modify the wireless network quality of service.

According to some embodiments, the device is classified as a multipurpose device and the method includes performing end to end quality of service management for the device by modifying the wireless network quality of service for the device and modifying slice key performance indicators for the device.

According to some embodiments, the method includes populating the service details with a first expected slice quality of service for a first application served by the device and a second expected slice quality of service for a second application served by the device.

According to some embodiments, the method includes in response to determining that slice key performance indicators for the device are to be modified, determining whether a user of the device is subscribed for a slice through a unified data manager; and in response to the user being subscribed to the slice, updating network slice selection functionality based upon a proposal provided by an application provider of an application of the device.

According to some embodiments, the method includes in response to determining that slice key performance indicators for the device are to be modified, determining that a user of the device is subscribed for a slice through a unified data manager; and in response to determining that the slice key performance indicators can be modified without changing network slice selection functionality, pushing a configuration change to at least one of a policy control function, a session management function, or an access and mobility management function.

According to some embodiments, the method includes updating a transport configuration for modification of the slice key performance indicators.

According to some embodiments, a system comprising one or more processors configured for executing the instructions to perform operations, is provided. The operations include generating a classification associated with a device connected to a wireless network through a router; storing service details for the device, wherein the service details correspond to expected wireless network quality of service to be provided by the wireless network to the device and corresponds to the classification; obtaining a current wireless network quality of service from the device; comparing the current wireless network quality of service with the service details for the device to identify a delta; and modifying wireless network quality of service for the device based upon the delta.

According to some embodiments, the operations include receiving, by a quality of service controller hosted within the router, an application provider response to an application call from the device for a quality of service set for an application served by the device, wherein the application provider response defines the quality of service set; and in response to determining that the device is executing the application, applying the quality of service set at the router for the application.

According to some embodiments, the operations include in response to determining that the device is executing a first application, applying a first quality of service set at the router for the first application; and in response to receiving a notification from the device that the device has switched to executing a second application, applying a second quality of service set for the second application.

According to some embodiments, the operations include receiving, by a domain name service mapper, a request for the expected wireless network quality of service; providing the expected wireless network quality of service to an application served by the device for configuring the router to apply the expected wireless network quality of service for the application.

According to some embodiments, a non-transitory computer-readable medium storing instructions that when executed facilitate performance of operations, is provided. The operations include generating a classification associated with a device connected to a wireless network through a router; storing service details for the device, wherein the service details correspond to expected wireless network quality of service to be provided by the wireless network to the device and corresponds to the classification; obtaining a current wireless network quality of service from the device; comparing the current wireless network quality of service with the service details for the device to identify a delta; and modifying wireless network quality of service for the device based upon the delta.

According to some embodiments, the operations include dynamically changing the quality of service provided to the device based upon an application call from an application currently executing on the device.

According to some embodiments, the operations include pushing quality of service values to a quality of service controller based upon a predefined configuration from a device provider of the device, wherein the quality of service controller utilizes the quality of service values to modify the wireless network quality of service.

According to some embodiments, the classification comprises at least one of a device classification, an application classification, an experience mode classification, temporal information, or location information.

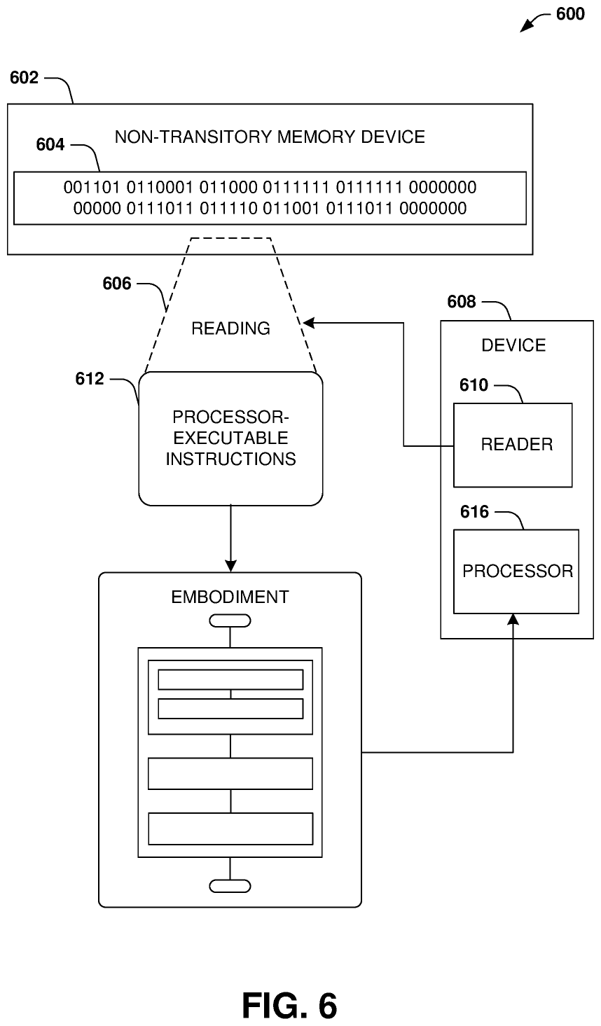

FIG. 6 is an interaction diagram of a scenario 600 illustrating a service 602 provided by a set of computers 604 to a set of client devices 610 via various types of transmission mediums. The computers 604 and/or client devices 610 may be capable of transmitting, receiving, processing, and/or storing many types of signals, such as in memory as physical memory states.

In some embodiments, the computers 604 may be host devices and/or the client device 610 may be devices attempting to communicate with the computer 604 over buses for which device authentication for bus communication is implemented.

The computers 604 of the service 602 may be communicatively coupled together, such as for exchange of communications using a transmission medium 606. The transmission medium 606 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 602.

Likewise, the transmission medium 606 may comprise one or more sub-networks, such as may employ different architectures, may be compliant or compatible with differing protocols and/or may interoperate within the transmission medium 606. Additionally, various types of transmission medium 606 may be interconnected (e.g., a router may provide a link between otherwise separate and independent transmission medium 606).

In scenario 600 of FIG. 6, the transmission medium 606 of the service 602 is connected to a transmission medium 608 that allows the service 602 to exchange data with other services 602 and/or client devices 610. The transmission medium 608 may encompass various combinations of devices with varying levels of distribution and exposure, such as a public wide-area network and/or a private network (e.g., a virtual private network (VPN) of a distributed enterprise).

In the scenario 600 of FIG. 6, the service 602 may be accessed via the transmission medium 608 by a user 612 of one or more client devices 610, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 610 may communicate with the service 602 via various communicative couplings to the transmission medium 608. As a first such example, one or more client devices 610 may comprise a cellular communicator and may communicate with the service 602 by connecting to the transmission medium 608 via a transmission medium 609 provided by a cellular provider. As a second such example, one or more client devices 610 may communicate with the service 602 by connecting to the transmission medium 608 via a transmission medium 609 provided by a location such as the user's home or workplace (e.g., a WiFi (Institute of Electrical and Electronics Engineers (IEEE) Standard 802.11) network or a Bluetooth (IEEE Standard 802.15.1) personal area network). In this manner, the computers 604 and the client devices 610 may communicate over various types of transmission mediums.

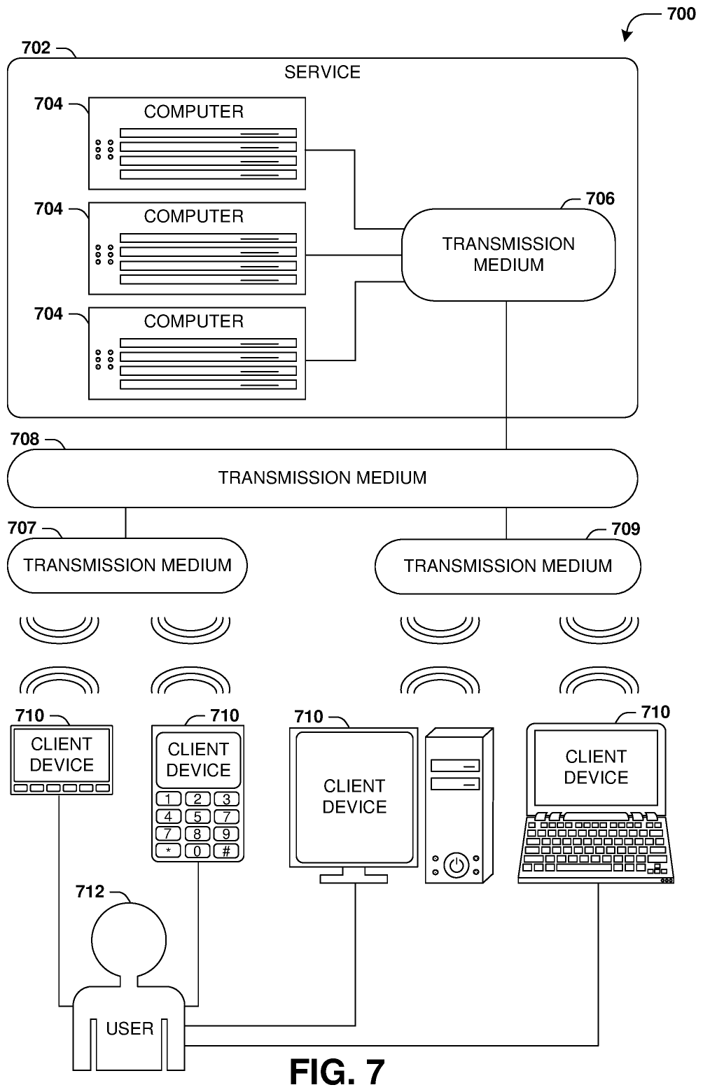

FIG. 7 presents a schematic architecture diagram 700 of a computer 704 that may utilize at least a portion of the techniques provided herein. Such a computer 704 may vary widely in configuration or capabilities, alone or in conjunction with other computers, in order to provide a service such as the service 702.

The computer 604 may comprise one or more processors 710 that process instructions. The one or more processors 710 may optionally include a plurality of cores; one or more coprocessors, such as a mathematics coprocessor or an integrated graphical processing unit (GPU); and/or one or more layers of local cache memory. The computer 704 may comprise memory 702 storing various forms of applications, such as an operating system 704; one or more computer applications 706; and/or various forms of data, such as a database 708 or a file system. The computer 704 may comprise a variety of peripheral components, such as a wired and/or wireless network adapter 714 connectible to a local area network and/or wide area network; one or more storage components 716, such as a hard disk drive, a solid-state storage device (SSD), a flash memory device, and/or a magnetic and/or optical disk reader.

The computer 704 may comprise a mainboard featuring one or more communication buses 712 that interconnect the processor 710, the memory 702, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 712 may interconnect the computer 704 with at least one other computer. Other components that may optionally be included with the computer 704 (though not shown in the schematic architecture diagram 700 of FIG. 7) include a display; a display adapter, such as a graphical processing unit (GPU); input peripherals, such as a keyboard and/or mouse; and a flash memory device that may store a basic input/output system (BIOS) routine that facilitates booting the computer 704 to a state of readiness.

The computer 704 may operate in various physical enclosures, such as a desktop or tower, and/or may be integrated with a display as an “all-in-one” device. The computer 704 may be mounted horizontally and/or in a cabinet or rack, and/or may simply comprise an interconnected set of components. The computer 704 may comprise a dedicated and/or shared power supply 718 that supplies and/or regulates power for the other components. The computer 704 may provide power to and/or receive power from another computer and/or other devices. The computer 704 may comprise a shared and/or dedicated climate control unit 720 that regulates climate properties, such as temperature, humidity, and/or airflow. Many such computers 704 may be configured and/or adapted to utilize at least a portion of the techniques presented herein.

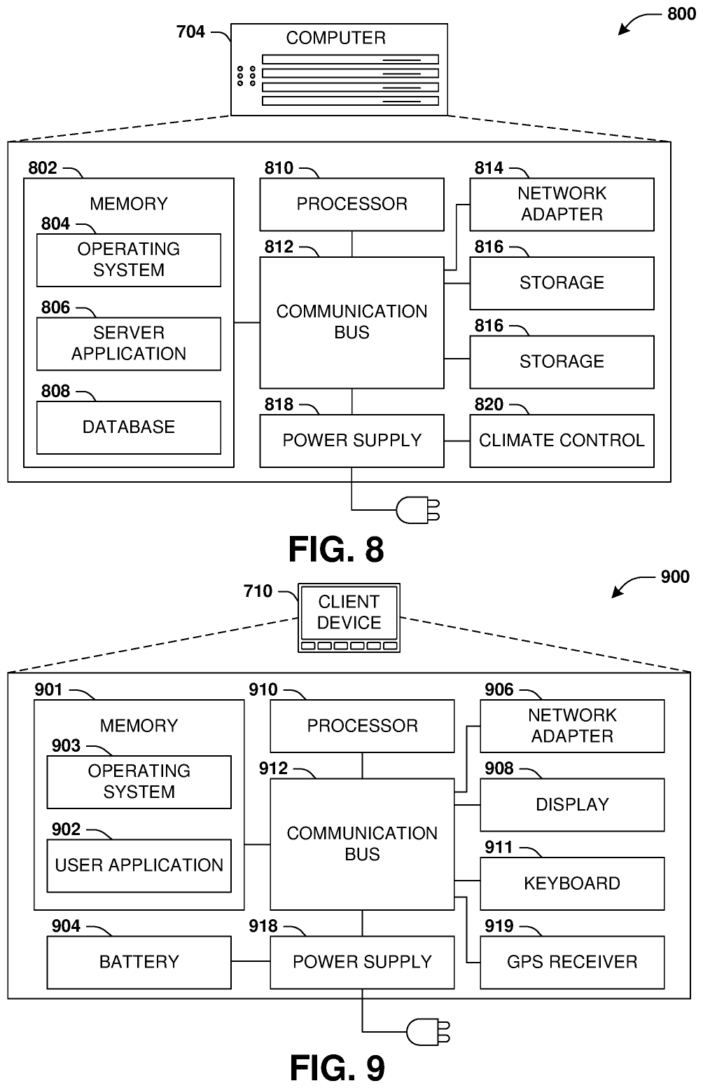

FIG. 8 presents a schematic architecture diagram 800 of a client device 710 whereupon at least a portion of the techniques presented herein may be implemented. Such a client device 710 may vary widely in configuration or capabilities, in order to provide a variety of functionality to a user such as the user 712. The client device 710 may be provided in a variety of form factors, such as a desktop or tower workstation; an “all-in-one” device integrated with a display 808; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 710 may serve the user in a variety of roles, such as a workstation, kiosk, media player, gaming device, and/or appliance.

The client device 710 may comprise one or more processors 810 that process instructions. The one or more processors 810 may optionally include a plurality of cores; one or more coprocessors, such as a mathematics coprocessor or an integrated graphical processing unit (GPU); and/or one or more layers of local cache memory. The client device 710 may comprise memory 801 storing various forms of applications, such as an operating system 803; one or more user applications 802, such as document applications, media applications, file and/or data access applications, communication applications such as web browsers and/or email clients, utilities, and/or games; and/or drivers for various peripherals. The client device 710 may comprise a variety of peripheral components, such as a wired and/or wireless network adapter 806 connectible to a local area network and/or wide area network; one or more output components, such as a display 808 coupled with a display adapter (optionally including a graphical processing unit (GPU)), a sound adapter coupled with a speaker, and/or a printer; input devices for receiving input from the user, such as a keyboard 811, a mouse, a microphone, a camera, and/or a touch-sensitive component of the display 808; and/or environmental sensors, such as a global positioning system (GPS) receiver 819 that detects the location, velocity, and/or acceleration of the client device 710, a compass, accelerometer, and/or gyroscope that detects a physical orientation of the client device 710. Other components that may optionally be included with the client device 710 (though not shown in the schematic architecture diagram 800 of FIG. 8) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 710 to a state of readiness; and a climate control unit that regulates climate properties, such as temperature, humidity, and airflow.

The client device 710 may comprise a mainboard featuring one or more communication buses 812 that interconnect the processor 810, the memory 801, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 710 may comprise a dedicated and/or shared power supply 818 that supplies and/or regulates power for other components, and/or a battery 804 that stores power for use while the client device 710 is not connected to a power source via the power supply 818. The client device 710 may provide power to and/or receive power from other client devices.

FIG. 9 is an illustration of a scenario 900 involving an example non-transitory machine readable medium 902. The non-transitory machine readable medium 902 may comprise processor-executable instructions 912 that when executed by a processor 916 cause performance (e.g., by the processor 916) of at least some of the provisions herein. The non-transitory machine readable medium 902 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 902 stores computer-readable data 904 that, when subjected to reading 906 by a reader 910 of a device 908 (e.g., a read head of a hard disk drive, or a read operation invoked on a solid-state storage device), express the processor-executable instructions 912. In some embodiments, the processor-executable instructions 912, when executed cause performance of operations, such as at least some of the example method 200 of FIG. 2, for example. In some embodiments, the processor-executable instructions 912 are configured to cause implementation of a system, such as at least some of the example system 100 of FIG. 1 and/or at least some of the example system 300 of FIG. 3.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A method, comprising:
generating a classification associated with a device connected to a wireless network through a router;
storing service details for the device, wherein the service details correspond to expected wireless network quality of service to be provided by the wireless network to the device and corresponds to the classification;
obtaining a current wireless network quality of service from the device;
comparing the current wireless network quality of service with the service details for the device to identify a delta; and
modifying wireless network quality of service for the device based upon the delta.

2. The method of claim 1, wherein the classifying comprises:
evaluating a media access control address of the device to identify a manufacturer of the device;
utilizing the media access control address to perform an application programming interface call to a service to obtain device details of the device; and
classifying the device as a single purpose device or a multipurpose device based upon the device details.

3. The method of claim 1, wherein the classifying comprises:
identifying a device name of the device; and
classifying the device as a single purpose device or a multipurpose device based upon the device name.

4. The method of claim 1, wherein the classifying comprises:
accessing preconfigured device details and preconfigured quality of service information from the device;
classifying the device as a single purpose device or a multipurpose device based upon the preconfigured device details; and
utilizing the preconfigured quality of service information to derive the expected wireless network quality of service.

5. The method of claim 1, comprising:
in response to detecting a reconnection of the device, querying the device registry to identify the classification of the device.

6. The method of claim 1, wherein the storing comprises:
populating a domain name service mapper with an entry for the device, within the entry is populated with a destination IP address, an application identifier, an application type, and the expected wireless network quality of service.

7. The method of claim 1, wherein the modifying comprises:
pushing, by a quality of service rule engine, quality of service values to a quality of service controller based upon a predefined configuration from a device provider of the device, wherein the quality of service controller utilizes the quality of service values to modify the wireless network quality of service.

8. The method of claim 1, wherein the device is classified as a multipurpose device, and wherein the method comprises:
performing end to end quality of service management for the device by modifying the wireless network quality of service for the device and modifying slice key performance indicators for the device.

9. The method of claim 1, comprising:
populating the service details with a first expected slice quality of service for a first application served by the device and a second expected slice quality of service for a second application served by the device.

10. The method of claim 1, comprising:
in response to determining that slice key performance indicators for the device are to be modified, determining whether a user of the device is subscribed for a slice through a unified data manager; and
in response to the user being subscribed to the slice, updating network slice selection functionality based upon a proposal provided by an application provider of an application of the device.

11. The method of claim 1, comprising:
in response to determining that slice key performance indicators for the device are to be modified, determining that a user of the device is subscribed for a slice through a unified data manager; and
in response to determining that the slice key performance indicators can be modified without changing network slice selection functionality, pushing a configuration change to at least one of a policy control function, a session management function, or an access and mobility management function.

12. The method of claim 11, comprising:
updating a transport configuration for modification of the slice key performance indicators.

13. A system, comprising:
one or more processors configured for executing instructions to perform operations comprising:
generating a classification associated with a device connected to a wireless network through a router;
storing service details for the device, wherein the service details correspond to expected wireless network quality of service to be provided by the wireless network to the device and corresponds to the classification;
obtaining a current wireless network quality of service from the device;
comparing the current wireless network quality of service with the service details for the device to identify a delta; and
modifying wireless network quality of service for the device based upon the delta.

14. The system of claim 13, wherein the operations comprise:
receiving, by a quality of service controller hosted within the router, an application provider response to an application call from the device for a quality of service set for an application served by the device, wherein the application provider response defines the quality of service set; and
in response to determining that the device is executing the application, applying the quality of service set at the router for the application.

15. The system of claim 13, wherein the operations comprise:
in response to determining that the device is executing a first application, applying a first quality of service set at the router for the first application; and
in response to receiving a notification from the device that the device has switched to executing a second application, applying a second quality of service set for the second application.

16. The system of claim 13, wherein the operations comprise:
receiving, a the domain name service mapper, a request for the expected wireless network quality of service;
providing the expected wireless network quality of service to an application served by the device for configuring the router to apply the expected wireless network quality of service for the application.

17. A non-transitory computer-readable medium storing instructions that when executed facilitate performance of operations comprising:
generating a classification associated with a device connected to a wireless network through a router storing service details for the device, wherein the service details correspond to expected wireless network quality of service to be provided by the wireless network to the device and corresponds to the classification;
obtaining a current wireless network quality of service from the device;
comparing the current wireless network quality of service with the service details for the device to identify a delta; and
modifying wireless network quality of service for the device based upon the delta.

18. The non-transitory computer-readable medium of claim 17, wherein the operations comprise:
dynamically changing quality of service provided to the device based upon an application call from an application currently executing on the device.

19. The non-transitory computer-readable medium of claim 17, wherein the operations comprise:
pushing quality of service values to a quality of service controller based upon a predefined configuration from a device provider of the device, wherein the quality of service controller utilizes the quality of service values to modify the wireless network quality of service.

20. The non-transitory computer-readable medium of claim 17, wherein the classification comprises at least one of a device classification, an application classification, an experience mode classification, temporal information, or location information.
